(19) United States
(12) Patent Application Publication
(10) Pub. No.: US 2010/0119706 A1
(43) Pub. Date: May 13, 2010

(54) METHOD FOR THE PRODUCTION OF AN ABRADABLE COATING

(75) Inventor: Andre Werner, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/597,163

(22) PCT Filed: Apr. 12, 2008
(86) PCT No.: PCT/DE08/00617

§ 371 Date: Oct. 22, 2009

(30) Foreign Application Priority Data
Apr. 25, 2007 (DE) 10 2007 019 476.7

(51) Int. Cl. B05D 1/12

(52) U.S. Cl. 427/180

(57) ABSTRACT

A method for producing an abradable coating for a component of a turbo-machine is disclosed. The method includes a) a powdery material is pretreated; b) a processable preliminary product is produced which is to be applied to a component that is to be coated; c) the preliminary product is applied to the component that is to be coated; d) a synthetic binder contained in the preliminary product is burned off; e) the component is sintered; and f) the component is post-processed. The method for producing an abradable coating for a turbo-machine eliminates the drawbacks of the solutions known from the prior art. In particular, the method is inexpensive, can easily be combined with other production process steps, for example, thermal treatments that have to be carried out anyway, and is also suitable as a method for repairs.

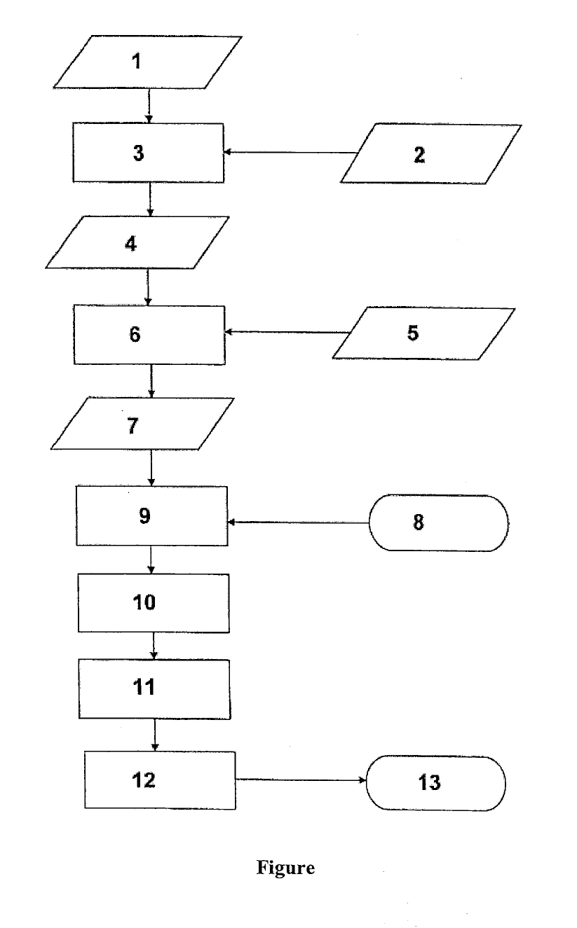

This application claims the priority of International Application No. PCT/DE2008/000617, filed Apr. 12, 2008, and German Patent Document No. 10 2007 019 476.7, filed Apr. 25, 2007, the disclosures of which are expressly incorporated by reference herein.

### BACKGROUND AND SUMMARY OF THE INVENTION

The invention relates to a method for producing an abradable coating for a component of a turbo-machine.

Abradable coatings are in widespread use in the construction of turbo-machines and engines in order to optimize gap seals. The degree of efficiency of an engine depends to a great degree on the gaps between the rotor and stator. In this connection, a gap seal is normally comprised of two abradable coatings, a running-in coating, which is partially abraded during rubbing, and an abradable lining, which has an abrasive effect and during rubbing gets incorporated into the running-in coating. Running-in coatings are normally comprised of an abradable material component in the form of particles and a connecting material component, normally made of metal. This metal can also be present in a structured manner as a support matrix in the form of honeycombs or other matrix shapes, wherein the interstices are filled with ceramic and/or metal coatings.

European Patent Document No. EP 0 166 940 discloses a running-in coating for a turbo-machine, in particular for a gas turbine. In this case, a solid, dense and superficially smooth coating of moderate hardness is produced using coating technology from particles having a non-metallic core and metal sheath. This coating is sintered and/or pressed.

German Patent Document No. DE 44 27 264 A1 describes a method for producing an abradable coating for engine components having an abradable or an abrasive material component in the form of particles and a material component connecting these, wherein, first of all, a mixed ceramic powder is produced by mixing components in powder form that are required for the abradable coating, sintering the powder mixture and pulverizing the sintered mass so that the components of the abradable coating are contained in every particle of the powder, and the resulting mixed powder is then plasma sprayed or flame sprayed as a coating powder directly on the component surface or on a bonding layer.

These types of mixed powders for plasma spraying are described in European Patent Document No. EP 0 771 884 B1 for example. This document discloses a thermal spray powder made of boron nitride and aluminum particles with a synthetic polymer binder. Additional mixed powders for plasma spraying are disclosed in European Patent Document No. EP 0487 273 B1.

Running-in coatings that are produced by sintering from powdery preliminary products must either be sintered at high temperatures or produced by the addition of sintering aids. Sintering at high temperatures requires a separate and therefore costly and time-consuming sintering step. The problem when using aids to sintering, for example, by adding solder materials, is that a non-uniform distribution of the sintering sinter bridges occurs in the process as well as accumulations of soldered and non-soldered areas.

In the case of running-in coatings that are produced by thermal spraying, for example, it is either not possible to coat very small and inaccessible inside diameters at all or only with greatly increased effort.

The objective of the invention is therefore to eliminate the drawbacks of the solutions known from the prior art and provide an improved method for producing an abradable coating for a turbo-machine. In particular, the invention intends to make available a method that is inexpensive, that can easily be combined with other production process steps, and that is also suitable as a method for repairs.

An inventive method for producing an abradable coating for a component of a turbo-machine, comprises the followings steps:

a) a powdery material, e.g., a multi-component powder, is pretreated;

b) a processable preliminary product is produced which is to be applied to a component that is to be coated;

c) the preliminary product is applied to the component that is to be coated;

d) a synthetic binder contained in the preliminary product is burned off;

e) sintering;

f) post-processing.

The improved method for producing an abradable coating for a turbo-machine hereby eliminates the drawbacks of the solutions known from the prior art. In particular, the inventive method is inexpensive, can easily be combined with other production process steps, e.g., thermal treatments that have to be carried out anyway, and is also suitable as a method for repairs. In addition, it is also possible to coat component regions such as small inaccessible inside diameters, something that is not feasible using other methods such as, for example, thermal spraying. Hollow spheres or low-strength non-metallic materials are preferably suitable for adjusting the special properties of a running-in coating.

An advantageous further development of the method is characterized in that in step a) the powdery material is sheathed with a thin metallic coating, which is provided as an aid to sintering. Coating the powdery preliminary product with a sintering auxiliary material makes it possible, on the one hand, to lower the process temperatures during sintering and, on the other hand, for uniform sintering within the powder particles to take place.

Another advantageous further development of the method is characterized in that the metallic coating is carried out by chemical nickel-plating. This results in a nickel layer with a phosphorus portion on the surface of the powder particles. The mixture of nickel and phosphorous subsequently serves as an aid to sintering.

Moreover, an advantageous further development of the method is characterized in that the powdery material features hexagonal boron nitride, graphite, calcium bifluoride, etc. In this case, these are low-strength non-metallic materials, which are preferably used in running-in coatings.

An advantageous further development of the method is characterized in that in step b) the pretreated powdery material is mixed with a suitable binding agent. For example, synthetics such as cellulose ester or polyvinyl alcohol are used as binding agents in this case.

Another advantageous further development of the method is characterized in that either a preparation of slurry, paste or a preform body or green body is prepared. In the case of a slurry or paste, a corresponding low-viscosity to high-viscosity preparation can be produced. In the case of a preform body or tape, a green body is produced.

A further advantageous further development of the method is characterized in that in step c) the slurry or paste is applied by spraying, dip coating, painting or smoothing. Another advantageous further development of the method is characterized in that in step c) the application of the preform body is carried out by placing and partially dissolving the synthetic binding agent. In this case, it is a “gluing in place” in a certain respect.

Additional measures improving the invention are explained in greater detail in the following on the basis of the enclosed FIGURE along with a description of a preferred exemplary embodiment of the invention.

### BRIEF DESCRIPTION OF THE DRAWING

The single FIGURE shows a flow chart of an advantageous method for producing an abradable coating for a turbo-machine in accordance with the present invention.

### DETAILED DESCRIPTION OF THE DRAWING

According to the process flow depicted in the FIGURE, in process step 1 a powdery material is made available, which in the case at hand is comprised of hollow spheres or low-strength non-metallic materials, e.g., solid lubricants such as hexagonal boron nitride, graphite, calcium bifluoride, etc., or even highly porous clay minerals such as bentonite.

In process step 2, a metallic coating material, e.g., NiCrAl or nickel with a phosphorus portion, is made available.

In process step 3, the multi-component powder from process step 1 is pretreated in such a way that it is thinly coated with the metal coating from process step 2 so that the powder is completely sheathed. In the case at hand, the coating takes place in the form a chemical nickel-plating. In this case, a nickel layer with a phosphorus portion forms on the surface of the powder particles.

In process step 4, the powder covered with a thin metal coating is made available for further processing. The thin metal coating of the powder comprised of nickel and phosphorus serves as an aid to sintering in the further process.

In process step 5, a binding agent is made available. Cellulose ester, polyvinyl alcohol or any other suitable synthetic binder is a possibility as the binding agent in this case.

In process step 6, the coated powder is mixed with the binding agent in order to prepare the coated powder for further processing. In this process step, the metal-coated powder is transformed into a processable form suitable for application to a component that is to be processed. In this case, the powder can be processed with the binder into a slurry, a paste, or a preform body (tape).

In process step 7, the to-be-processed preliminary product is made available. The preliminary product is now available as a slurry, paste or preform body. In the case of a slurry or paste, a correspondingly low-viscosity to high-viscosity preparation is produced. In the case of a tape, a green body is produced.

In process step 8, the component prepared for coating with a running-in coating is made available. In this case in particular, heat treatment steps may still be pending.

In process step 9, the preliminary product is applied by means of a suitable application process to the to-be-processed component. In the case of a slurry or paste, it is applied by spraying, dip coating, painting or smoothing. In the case of the tape, application is accomplished by placing and partially dissolving the synthetic binding agent using a suitable solvent. In this case, we can speak of virtually “gluing in place.”

In process step 10, the synthetic binder is burned off the thusly prepared component at a suitable temperature. In the process, the green compact of the layer, i.e., the preform of the running-in coating, forms on the component being processed.

In process step 11, the component with the green compact of the layer is sintered at a suitable temperature. In doing so, the coating on the powder particles produces the uniform development of sinter bridges between the individual powder particles as well as the connection to the component that is to be coated.

In process step 12, the running-in coating of the finished sintered component is post-processed. In this case, suitable methods such as, for example, turning and milling, are used depending upon the component type and component geometric. This eliminates burrs and unevenness and adjusts the desired surface properties of the running-in coating.

In process step 13, the component with a finished running-in coating is then ready.

In terms of its design, the invention is not restricted to the preferred exemplary embodiment disclosed in the foregoing. In fact, a number of variations are conceivable, which even in the case of a different design make use of the solution claimed in the patent claims.

1-8. (canceled)

9. A method for producing an abradable coating for a component of a turbo-machine, comprising the steps of:
a) pre-treating a powdery material;
b) producing a processable preliminary product which is to be applied to a component that is to be coated from the pre-treated powdery material;
c) applying the preliminary product to the component that is to be coated to form a coated component;
d) burning off a synthetic binder contained in the preliminary product from the coated component;
e) sintering the coated component; and
f) post-processing the sintered component.

10. The method according to claim 9, wherein in step a) the powdery material is sheathed with a thin metallic coating.

11. The method according to claim 10, wherein the metallic coating is carried out by chemical nickel-plating.

12. The method according to claim 9, wherein the powdery material includes hexagonal boron nitride, graphite, or calcium bifluoride.

13. The method according to claim 9, wherein in step b) the pre-treated powdery material is mixed with a binding agent.

14. The method according to claim 9, wherein the preliminary product is a slurry, a paste, or a preform body.

15. The method according to claim 9, wherein in step c) the preliminary product is a slurry or a paste and is applied by spraying, dip coating, painting or smoothing.

16. The method according to claim 9, wherein in step c) the preliminary product is a preform body and is applied by placing and partially dissolving a synthetic binding agent.
